(19) United States
(12) Patent Application Publication
(10) Pub. No.: US 2025/0330304 A1
(43) Pub. Date: Oct. 23, 2025

(54) PROCESSING METHOD AND ELECTRONIC DEVICE

(71) Applicant: Lenovo (Beijing) Limited, Beijing (CN)

(72) Inventors: Helai WANG, Beijing (CN); Siming ZHU, Beijing (CN)

(21) Appl. No.: 19/178,586

(22) Filed: Apr. 14, 2025

(30) Foreign Application Priority Data
Apr. 18, 2024 (CN) 202410472403.X

(51) Int. Cl. H04L 9/08

(52) U.S. Cl. CPC H04L 9/0819; H04L 9/0861

(57) ABSTRACT

A processing method and electronic device are provided. The processing method applied to the electronic device includes obtaining a key to be used from a security hardware module of the electronic device; and encrypting local user data on the electronic device based on the key to be used to generate encrypted user data, enabling an application on the electronic device to perform local processing in response to a user input to the application.

### CROSS-REFERENCE TO RELATED APPLICATION

This application claims priority of Chinese Patent Application No.: 202410472403X, filed on Apr. 18, 2024, the entire contents of which are hereby incorporated by reference.

### FIELD OF THE DISCLOSURE

The present disclosure generally relates to the field of computer technology and, more particularly, relates to a processing method and an electronic device.

### BACKGROUND

With the continuous development of the Internet, users are increasingly concerned about the data security in electronic devices. Therefore, protecting electronic device data has become a critical issue.

### BRIEF SUMMARY OF THE DISCLOSURE

One aspect of the present disclosure provides a processing method. The processing method is applied to an electronic device and includes obtaining a key to be used from a security hardware module of the electronic device; and encrypting local user data on the electronic device based on the key to be used to generate encrypted user data, the encrypted user data being configured to enable an application on the electronic device to perform local processing in response to a user input to the application.

Another aspect of the present disclosure provides an electronic device. The electronic device includes a security hardware module for storing a key to be used; and one or more processors for obtaining the key to be used from the security hardware module and encrypting local user data on the electronic device based on the key to be used to obtain encrypted user data. The encrypted user data is configured to enable an application on the electronic device to perform local processing in response to a user input to the application.

Other aspects of the present disclosure can be understood by a person skilled in the art in light of the description, the claims, and the drawings of the present disclosure.

### BRIEF DESCRIPTION OF THE DRAWINGS

To clearly describe technical solutions in embodiments of the present disclosure, accompanying drawings required for the embodiments of the present disclosure will be briefly introduced below. Obviously, the accompanying drawings described below represent only some embodiments of the present disclosure. A person skilled in the art may further derive other drawings from the accompanying drawings without creative efforts.

FIG. 1 illustrates a flow chart of a processing method consistent with various embodiments of the present disclosure.

FIG. 2 illustrates a schematic diagram of a transmission path consistent with various embodiments of the present disclosure.

FIG. 3 illustrates a flow chart of another processing method consistent with various embodiments of the present disclosure.

FIG. 4 illustrates a flow chart of another processing method consistent with various embodiments of the present disclosure.

FIG. 5 illustrates a flow chart of another processing method consistent with various embodiments of the present disclosure.

FIG. 6 illustrates a schematic diagram of an implementation scenario of a processing method consistent with various embodiments of the present disclosure.

FIG. 7 illustrates a flow chart of another processing method consistent with various embodiments of the present disclosure.

FIG. 8 illustrates a schematic diagram of another implementation scenario of a processing method consistent with various embodiments of the present disclosure.

FIG. 9 illustrates a flow chart of another processing method consistent with various embodiments of the present disclosure.

FIG. 10 illustrates a schematic diagram of an electronic device consistent with various embodiments of the present disclosure.

### DETAILED DESCRIPTION

Technical solutions in the embodiments of the present disclosure will be clearly and comprehensively described below with reference to accompanying drawings in the embodiments of the present disclosure. Obviously, the described embodiments are only some not all embodiments of the present disclosure. Based on the embodiments in the present disclosure, all other embodiments obtained by those of ordinary skill in the art without creative efforts fall within the protection scope of the present disclosure.

Currently, generative artificial intelligence (generative AI) applications on personal computers (PCs) primarily rely on cloud computing for processing. User data required by the generative AI applications needs to be uploaded to the cloud, where the generative AI applications are processed based on user data. However, in the process of uploading user data to the cloud, user data is vulnerable to interception or eavesdropping, leading to poor data security.

To improve user data security, the present disclosure proposes to deploy generative AI applications locally on electronic devices. By processing user data locally, generative AI applications can generate customized content without the need to upload data to the cloud. The approach enhances user data security and alleviates concerns about personal data privacy.

However, the user data used by generative AI applications is generally obtained in the following ways: collecting and organizing user data from a plurality of locations on the PC (i.e., word documents, PPT documents, Excel documents and the like) into designated folders. A user can either collect and organize user data from the plurality of locations on the PC into designated folders, or generative AI applications also collect and organize user data from the plurality of locations on the PC into designated folders. Once organized, embedding technology is used to generate user data (i.e., structured relational data and structured vector data) that can be used by generative AI applications from the user data in the designated folders, thereby integrating the user data into the generative AI application. The method consolidates user data, but if the generative AI applications are maliciously copied, user data could be lost. Therefore, the present disclosure proposes a processing method to protect user data.

The present disclosure will be described in further detail below with reference to the accompanying drawings and specific embodiments.

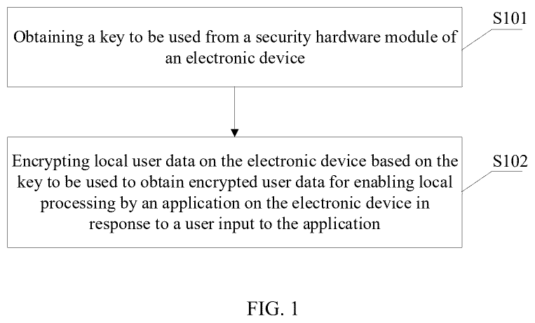

FIG. 1 illustrates a flow chart of a processing method provided in Embodiment 1 of the present disclosure. The processing method can be applied to electronic devices. The present disclosure does not limit product types of the electronic devices. As shown in FIG. 1, the method may include but is not limited to the following steps.

S101: obtaining a key to be used from a security hardware module of an electronic device.

In the present embodiment, the security hardware module of the electronic device can generate a key to be used. The security hardware module of an electronic device can be a chip with a cryptographic engine, which generates a key to be used based on an encryption algorithms. For example, the security hardware module of the electronic device may be an LA1 chip or an LA3 chip. The LA1 chip can generate a key to be used based on a secure hash algorithm (SHA) with a key length of 256 bits, AES with a key length of 128 bits, or RSA with a key length of 2048 bits.

The LA3 chip can generate a key to be used based on SHA-1, SHA-224, SHA-256, SHA-384 or SHA-512 with key length can be 160 bits, 224 bits, 256 bits, 384 bits or 512 bits respectively. Alternatively, the LA3 chip can generate a key to be used based on AES with key lengths of 128 bits, 192 bits, or 256 bits. Alternatively, the LA3 chip can generate a key to be used based on RSA with key lengths of 1024 bits, 2048 bits, 3072 bits, 4096 bits, or based on ECC with key lengths of 192 bits or 256 bits.

A security hardware module can store and manage keys to be used. The security hardware module can allocate storage space for storage and backup the keys to be used. For example, the security hardware module can allocate 16K Bytes of free storage space, supporting 8 key groups. Each key group is 1 KB, totaling 8 KB, while the remaining 8 KB is used for backup.

If the storage space allocated for the keys to be used is full, first prompt information may be output, notifying the user to clear keys that meet the set conditions.

The keys to be used that meet the set conditions may include but are not limited to keys to be used that are least used within a specified period.

Based on the first prompt information, the keys to be used that meet the set conditions in the storage space can be cleared to free up storage space.

If the storage space allocated for the key to be used is full, second prompt information may also be output. The second prompt information is configured to prompt processing of the encrypted user data corresponding to a key to be used that meets the set conditions.

Once the key to be used that meet the set conditions are cleared, the corresponding encrypted user data can no longer be decrypted. Based on the second prompt information, the encrypted user data associated with the key to be used will be deleted from the specified folder to free up storage space.

In the present embodiment, the key to be used can be obtained from the security hardware module of the electronic device via a transmission path corresponding to the security hardware module.

The transmission path may include a first transmission path or a second transmission path.

The first transmission path can obtain the key to be used from the security hardware module using an embedded controller (EC) chip and an operating system. When the electronic device is turned on, a basic input output system (BIOS) can provide a WMI interface and write the WMI interface into memory. An application can call the WMI interface and use the first transmission path to obtain the key to be used from the security hardware module via the EC chip and the operating system.

The second transmission path may obtain the key to be used from the security hardware module using a driver of the electronic device. The electronic device includes the driver corresponding to the security hardware module. When the security hardware module exists in the electronic device, the operating system can automatically identify the security hardware module and implement data transmission between the security hardware module and the application using the corresponding driver.

Compared to the first transmission path, the second transmission path does not require access to the BIOS, operating system, and EC chip, making a retrieval of the key to be used based on the second transmission path more efficient.

The application can query the BIOS and the security hardware module supported by the electronic device. If the security hardware module supports the first transmission path, the application can call the WMI interface. If the query indicates that the security hardware module supports the second transmission path, the application can call a Crypto Library interface.

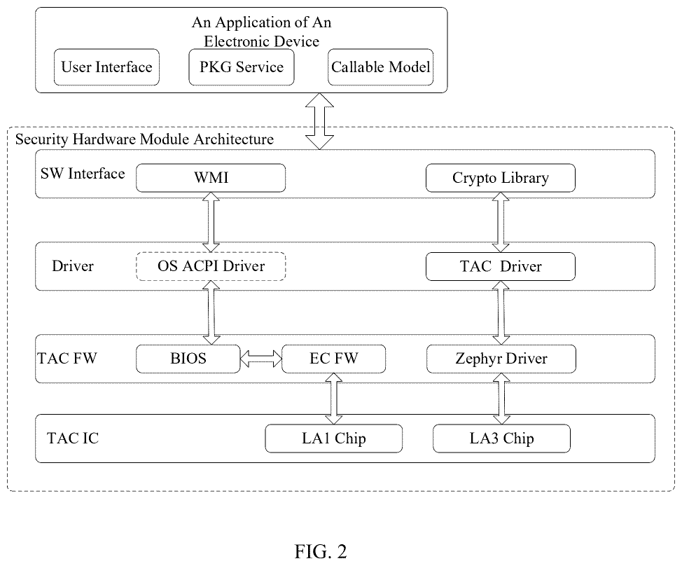

As shown in FIG. 2, the security hardware module of the electronic device includes the LA1 chip and LA3 chip. The LA1 chip supports the first transmission path. The application can call the WMI interface to obtain the key to be used from the LA1 chip through a firmware (EC FW) in the EC chip and a driver of the operating system (OS ACPI Driver).

It should be noted that based on the first transmission path, the BIOS is not involved. The BIOS in FIG. 2 is configured to illustrate that the WMI interface is written into memory by the BIOS when the electronic device is turned on.

The LA3 chip supports the second transmission path. For example, the LA3 chip can be considered as a USB device, and the operating system can automatically identify the LA3 chip, obtain the key to be used from the LA3 chip based on a corresponding USB driver (i.e., a LA3 firmware (Zephyr Driver) and a driver corresponding to LA3 in the operating system), and send the key to be used to the application through the application's Crypto Library interface.

It should be noted that FIG. 2 is merely an example of a transmission path and is not intended to limit the transmission path.

S102: encrypting local user data on the electronic device based on the key to be used to obtain encrypted user data for enabling local processing by an application on the electronic device in response to a user input to the application.

If the electronic device has a plurality of applications, each application can obtain a different key to be used from the security hardware module of the electronic device and encrypt the locally applied user data based on the respective key to be used, to obtain encrypted user data corresponding to each application.

Applications on electronic devices may include but are not limited to smart assistants, creative applications for writing, drawing and editing, game applications, educational applications, and the like. The applications can call local large models and personal knowledge graph data services (PKG Service) for local data analysis and processing. A user interface provided by an application facilitates interaction between the application and a user. For example, the application can obtain input from the user through the user interface.

In the present disclosure, there is no limitation on types of local applications on the electronic device. For example, applications local to the electronic device may include, but are not limited to generative AI applications running locally on the electronic device.

It is understood that the application can perform local processing based on local computing resources of the electronic device.

In the embodiment, by obtaining the key to be used from the security hardware module of the electronic device and encrypting the local user data on the electronic device based on the key to be used at the hardware level of the security hardware module, the security of the local user data on the electronic device can be improved. For example, a local application (a) on PC A obtains a key to be used from a security hardware module (A) on PC A and encrypts user data local to PC A based on the key to be used, to obtain encrypted user data. If a user maliciously copies the application (a) to PC B, the encrypted user data will also be copied to PC B. Since PC B does not have the security hardware module (A), application (a) cannot obtain the key to be used on PC B, and therefore cannot decrypt the encrypted user data, so that the user data from PC A is not leaked.

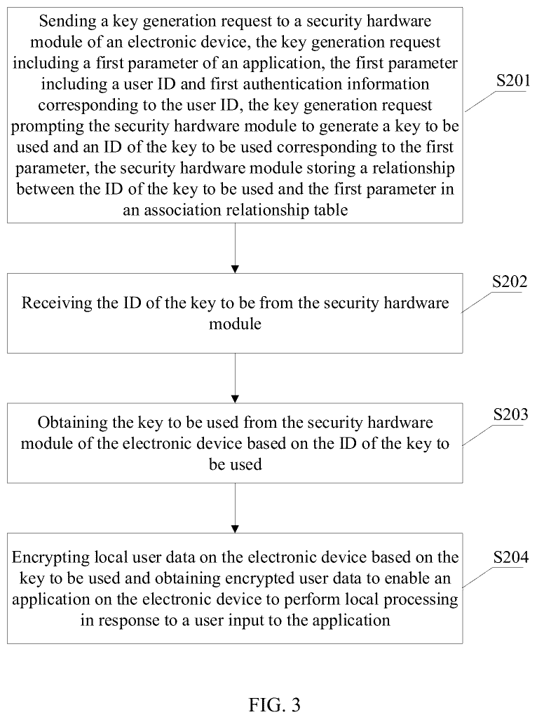

As another optional embodiment of the present disclosure, FIG. 3 illustrates a flow chart of a processing method provided in Embodiment 2 of the present disclosure. As shown in FIG. 3, the method may include but is not limited to the following steps. S201: sending a key generation request to a security hardware module of an

electronic device, the key generation request including a first parameter of an application, the first parameter including a user ID and first authentication information corresponding to the user ID, the key generation request prompting the security hardware module to generate a key to be used and an ID of the key to be used corresponding to the first parameter, the security hardware module storing a relationship between the ID of the key to be used and the first parameter in an association relationship table.

In the embodiment, every time a user opens an application on the electronic device, a user ID is required to be input through the application's user interface. Additionally, a personal knowledge graph data service of the application can randomly generate the first authentication information corresponding to the user ID when the user logs in to the application for a first time.

Unlike an embodiment in which the personal knowledge graph data service of the application can randomly generate the first authentication information corresponding to the user ID, the first authentication information corresponding to the user ID can also be manually input by the user through the user interface.

After obtaining the user ID and the first authentication information corresponding to the user ID, the personal knowledge graph data service of the electronic device application may send a key generation request to the security hardware module of the electronic device without needing to send a key generation request to the security hardware module of the electronic device corresponding to the user ID.

The ID of the key to be used may indicate a storage location of the key to be used in a secure storage module.

In the embodiment, it is not limited to saving a correspondence between the ID of the key to be used and the first parameter in the association relationship table. The security hardware module can also store the correspondence between the ID of the key to be used and the user ID in the association relationship table. The first authentication information can be stored alongside the key to be used in a designated storage location. When needed, the first authentication information can be retrieved from the designated storage location based on the association relationship table that records the correspondence between the ID of the key to be used and the user ID.

After saving the correspondence between the ID of the key to be used and the first parameter in the association relationship table, each time the security hardware module receives a new key generation request, the security hardware module can update the association relationship table based on the first parameter included in the new key generation request. For example, when user (A) opens an application and enters a user ID (user0001) through the user interface, and the personal knowledge graph data service can send a first key generation request to the security hardware module. The first key generation request may include a first parameter (n1). The first parameter (n1) may include the user ID (user0001) and first authentication information (P1) corresponding to (user0001). The security hardware module may generate a key to be used (key1) corresponding to the first parameter (n1) and an ID (0x00) of the key to be used (key1) and save a corresponding relationship between the ID of the key to be used and the first parameter in the association relationship table. The association relationship table is shown in Table 1. In Table 1, Key ID Data represents the user ID, Key Handle represents the ID of the key to be used, and Key AT represents the first authentication information.

TABLE 1

| Key Handle | Key ID Data | Key AT |
|---|---|---|
| 0x00 | user0001 | P1 |

User B can open an application and enter a user ID (user0002) through the user interface. The personal knowledge graph data service can send a second key generation request to the security hardware module. The second key generation request can include a first parameter (n2), which can include the user ID (user0002) and corresponding first authentication information (P2). The security hardware module can generate a key to be used (key2) corresponding to the first parameter (n2) and an ID (0x01) of the key to be used (key2). The security hardware module can update the association relationship table based on the first parameter (n2) and the ID (0x01) of the key to be used (key2). The updated association relationship table is shown in Table 2.

TABLE 2

| Key Handle | Key ID Data | Key AT |
|---|---|---|
| 0x00 | user0001 | P1 |
| 0x01 | user0002 | P2 |

User C can open an application and enter a user ID (user0003) through the user interface. The personal knowledge graph data service can send a third key generation request to the security hardware module. The third key generation request can include a first parameter (n3). The first parameter (n3) can include the user ID (user0003) and corresponding authentication information P3. The security hardware module can generate a key to be used (key3) corresponding to the first parameter (n3) and an ID (0x02) of the key to be used (key3). The security hardware module can update the association relationship table based on the first parameter (n3) and the ID (0x02) of the key to be used (key3). The updated association relationship table is shown in Table 3.

TABLE 3

| Key Handle | Key ID Data | Key AT |
|---|---|---|
| 0x00 | user0001 | P1 |
| 0x01 | user0002 | P2 |
| 0x02 | user0003 | P3 |

User D can open an application and enter a user ID (user0004) through the user interface. The personal knowledge graph data service can send a fourth key generation request to the security hardware module. The fourth key generation request can include a first parameter (n4). The first parameter (n4) can include a user ID (user0004) and corresponding authentication information (P4). The security hardware module can generate a key to be used (key4) corresponding to the first parameter (n4) and an ID (0x03) of the key to be used (key4). The security hardware module can update the association relationship table based on the first parameter (n4) and the ID (0x03) of the key to be used (key4). The updated association relationship table is shown in Table 4.

TABLE 4

| Key Handle | Key ID Data | Key AT |
|---|---|---|
| 0x00 | user0001 | P1 |
| 0x01 | user0002 | P2 |
| 0x02 | user0003 | P3 |
| 0x03 | user0004 | P4 |

The association relationship table is not limited to recording the relationship between the ID of the key to be used and the first parameter. The association relationship table may also record a storage status ID and an ID of the association relationship table corresponding to hardware parameters of the security hardware module. The storage status ID can be used to indicate whether the key to be used has been stored in the secure hardware module. For example, the ID of the association relationship table corresponding to the hardware parameters of the security hardware module can be set to (0x80). As the security hardware module in the electronic device is iteratively updated, the ID of the association relationship table is updated accordingly. For example, the ID of the association relationship table can be updated to (0x90). Based on the ID of the association relationship table, it can be determined which generation of the security hardware module generated or updated the association relationship table.

The storage status ID and the ID of the association relationship table corresponding to the hardware parameters of the security hardware module can be recorded. The association relationship table can be seen in Table 5. As shown in Table 5, (Key Segment) represents the ID of the association relationship table corresponding to the hardware parameters of the security hardware module. The Key Handle represents the ID of the key to be used, and

Status represents the storage status ID. A Status of 1 indicates that the key to be used has been stored in the security hardware module. A Status of 0 indicates that the key to be used is not stored in the security hardware module. Based on the Key Handle and the Status, it can be determined whether a corresponding storage location in the security hardware module contains a key to be used. (Key ID Data) represents the user ID, and (Key AT) represents the first authentication information.

TABLE 5

| Key Segment | Key Handle | Status | Key ID Data | Key AT |
|---|---|---|---|---|
| 0x80 | 0x00 | 1 | user0001 | P1 |
| 0x80 | 0x01 | 1 | user0002 | P2 |
| 0x80 | 0x02 | 1 | user0003 | P3 |
| 0x80 | 0x03 | 1 | user0004 | P4 |

In the embodiment, the association relationship table and the key to be used can also be uploaded to the cloud, where the association relationship table and the key are stored to enable a backup of the association relationship table and the key to be used.

S202: receiving the ID of the key to be used from the security hardware module.

It should be noted that when a user uses an application, the user will enter the user ID through the user interface. The application needs to match the user ID and obtain a corresponding key to be used from the security hardware module. Therefore, after the application receives the ID of the key to be used from the security hardware module, a corresponding relationship between the user ID and the ID of the key to be used can be saved in the associated data table on the application side.

S203: obtaining the key to be used from the security hardware module of the electronic device based on the ID of the key to be used.

After obtaining the user ID input by a user through the user interface, the ID of the key to be used corresponding to the user ID can be retrieved from the associated data table on the application side. Furthermore, based on the ID of the key to be used corresponding to the user ID, the corresponding key to be used can be obtained from the security hardware module.

S203 is an implementation of step S101 in Embodiment 1.

S204: encrypting local user data on the electronic device based on the key to be used and obtaining encrypted user data to enable an application on the electronic device to perform local processing in response to a user input to the application.

Detailed process of S204 can be referred to the relevant introduction of step S102 in Embodiment 1, which will not be repeated herein.

In the embodiment, by sending a key generation request to the security hardware module of the electronic device, which includes the first parameter of the application containing the user ID and first authentication information corresponding to the user ID, the security hardware module can generate the key to be used and the ID of the key to be used corresponding to the first parameter. The association relationship table is created to link the ID of the key to be used with the first parameter, allowing management of the key to be used based on the association relationship table.

Receiving the ID of the key to be used from the security hardware module completes the interaction between the application and the security hardware module in the key generation stage.

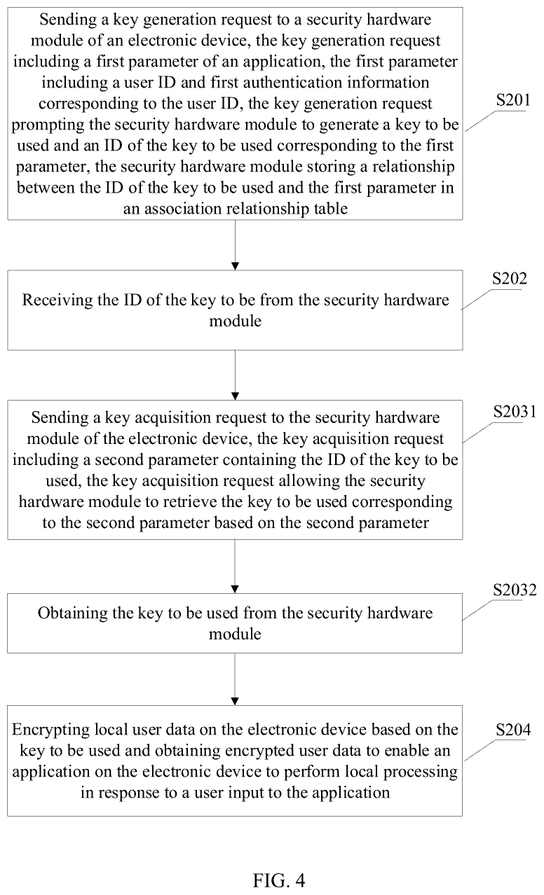

As another optional embodiment of the present disclosure, FIG. 4 illustrates a flow chart of a processing method provided in Embodiment 3 of the present disclosure. The embodiment primarily implements S203 in Embodiment 2. As shown in FIG. 4, S203 may include but is not limited to the following steps.

S2031: sending a key acquisition request to the security hardware module of the electronic device, the key acquisition request including a second parameter containing the ID of the key to be used, the key acquisition request allowing the security hardware module to retrieve the key to be used corresponding to the second parameter based on the second parameter. In the embodiment, after the security hardware module generates the key to be

used and the application receives the key to be used from the security hardware module, the application can send a key acquisition request to the security hardware module of the electronic device, and the key acquisition request can include the second parameter.

Correspondingly, the security hardware module may respond to the key acquisition request, retrieve the key to be used corresponding to the ID of the key to be used in the key acquisition request, and return the key to be used.

S2032: obtaining the key to be used from the security hardware module.

In the embodiment, an application on the electronic device can send a key generation request to the security hardware module, so that the security hardware module generates a corresponding key to be used. The application receives the ID of the key to be used from the security hardware module and sends a key acquisition request to the security hardware module, so that the security hardware module can respond to the key acquisition request, obtain the key to be used corresponding to the ID of the key to be used in the key acquisition request, and return the key to be used. Therefore, the security hardware module can generate the key to be used as needed. The application can also flexibly configure a timing of encryption. When encryption is required, the application simply sends the key acquisition request to obtain the key to be used.

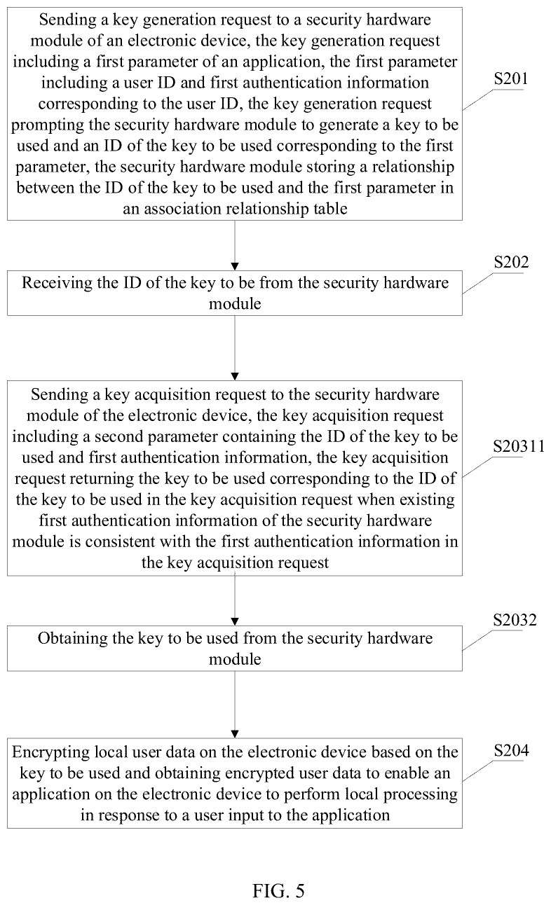

As another optional embodiment of the present disclosure, FIG. 5 illustrates a flow chart of a processing method provided in Embodiment 4 of the present disclosure. The embodiment primarily implements S2031 in Embodiment 3. As shown in FIG. 5, S2031 may include but is not limited to a following step.

S20311: sending a key acquisition request to the security hardware module of the electronic device, the key acquisition request including a second parameter containing the ID of the key to be used and first authentication information, the key acquisition request returning the key to be used corresponding to the ID of the key to be used in the key acquisition request when existing first authentication information of the security hardware module is consistent with the first authentication information in the key acquisition request.

Corresponding to the embodiment in which the correspondence between the ID of the key to be used and the first parameter is stored in the association relationship table, the first authentication information existing in the security hardware module is the first authentication information stored in the association relationship table of the security hardware module.

In the implementation in which the association relationship table stores the correspondence between the ID of the key to be used and the user ID, the first authentication information can be stored in a designated storage location along with the key to be used. Based on the association relationship table that records the correspondence between the ID of the key to be used and the user ID, the first authentication information can be retrieved from the designated storage location to obtain the existing first authentication information in the security hardware module.

In the embodiment, the first authentication information in the key generation request can be obtained through, but is not limited to, a following method: applying an elliptical encryption algorithm to generate an exchange key and determining the exchange key as the first authentication information.

After determining the first authentication information, the application may generate or update the association data table on the application side to record the relationship between the first authentication information and the user ID. Once the key generation request is sent to the security hardware module and the ID of the key to be used is obtained, the associated data table on the application side can be updated to include the relationship between the first authentication information, the user ID, and the ID of the key to be used.

Before the user uses the application (e.g., during the application loading process) or when the user uses the application, the corresponding key to be used can be retrieved from the security hardware module based on the associated data table on the application side, to decrypt the encrypted user data based on the key to be used.

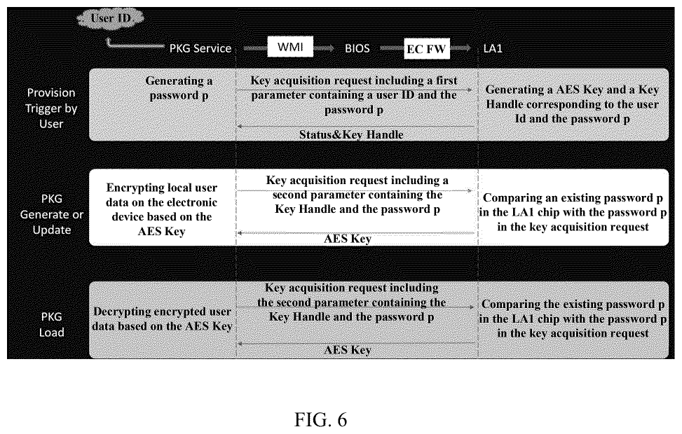

In the embodiment, a processing method is introduced through a key generation stage, a user data generation or update stage, and a loading application stage. For example, if the security hardware module can be an LA1 chip, as shown in FIG. 6, during the key generation stage (provision trigger by user), the PKG Service can randomly generate password (p) (i.e., an implementation of the first authentication information). The PKG Service can send a key generation request to the LA1 chip. The key generation request includes the first parameter. The first parameter includes the user ID and the password (p) corresponding to the user ID. The LA1 chip responds to the key generation request, generates the AES Key (the key to be used) and the Key Handle (the ID of the key to be used corresponding to the user ID) and password (p), and records the corresponding relationship between the Key Handle), Status, Key ID Data and password (p) in the association relationship table. The LA1 chip returns the Status and Key Handle to the PKG Service.

In the user data generation or update stage (PKG Generate or Update), the PKG Service can send a key acquisition request to the LA1 chip. The key acquisition request may include a second parameter, and the second parameter may include the Key Handle and the password (p). The LA1 chip responds to the key acquisition request and returns the AES Key corresponding to the Key Handle in the key acquisition request when the password (p) in the comparison association relationship table is consistent with the password (p) in the key acquisition request. The PKG Service can encrypt local user data on the electronic device based on the AES Key to obtain encrypted user data.

After obtaining the encrypted user data, during the application loading stage (PKG Load), the PKG Service can send a key acquisition request to the LA1 chip. The key acquisition request may include a second parameter containing the Key Handle and the password (p). The LA1 chip responds to the key acquisition request and returns the AES Key corresponding to the Key Handle in the key acquisition request when the existing password (p) in the LA1 chip is consistent with the password (p) in the key acquisition request. The PKG Service can decrypt encrypted user data based on AES Key and obtain local user data on the electronic device.

The application can send the key generation request and key acquisition request to the LA1 chip via the first transmission path by calling the WMI interface. The LA1 chip returns the Key Handle, Status, AES Key, and the like through the first transmission path.

In the embodiment, during the user data generation stage, user data update stage or application loading process, a key acquisition request is sent to the security hardware module of the electronic device, and the key acquisition request includes a second parameter containing the ID of the key to be used and the first authentication information. If the existing first authentication information of the security hardware module is consistent with the first authentication information in the key acquisition request, the key acquisition request is used to return the key to be used corresponding to the ID of the key to be used in the key acquisition request, thereby ensuring a safe delivery of the key to be used and further improving a security of local user data on the electronic device.

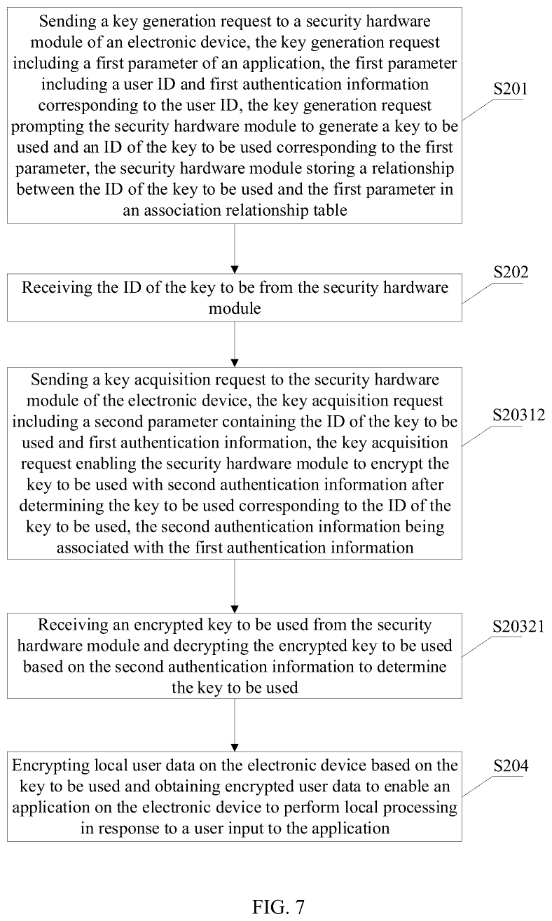

As another optional embodiment of the present disclosure, FIG. 7 illustrates a flow chart of a processing method provided in Embodiment 5 of the present disclosure. The embodiment primarily implements S2031 in Embodiment 3. As shown in FIG. 7, S2031 may include but is not limited to the following steps.

S20312: sending a key acquisition request to the security hardware module of the electronic device, the key acquisition request including a second parameter containing the ID of the key to be used and first authentication information, the key acquisition request enabling the security hardware module to encrypt the key to be used with second authentication information after determining the key to be used corresponding to the ID of the key to be used, the second authentication information being associated with the first authentication information.

The association between the second authentication information and the first authentication information may include, but is not limited to, generating the second authentication information based on the first authentication information. For example, the application can generate a first key pair using an ECDH encryption method. The first key pair includes a first public key and a first private key. The first public key is associated with the first private key. For example, the first private key is a, the first public key is A, and the relationship is defined as A=aG. The first public key can serve as the first authentication information.

In an implementation where the application randomly generates the first key pair, the security hardware module can generate a second key pair based on the ECDH encryption method in response to the key acquisition request. The second key pair can include a second public key and a second private key. The second public key is associated with the second private key. For example, if the second private key is b, the second public key is B, and the relationship is defined as B=bG.

A shared key of the secure hardware module may be generated based on the second private key and the first authentication information (i.e., the first public key). The shared key of the secure hardware module may be used as the second authentication information. For example, the second authentication information can be calculated as bA=baG.

S2032 may include but is not limited to a following step.

S20321: receiving an encrypted key to be used from the security hardware module and decrypting the encrypted key to be used based on the second authentication information to determine the key to be used.

In the embodiment, the second authentication information used by the application is not returned by the security hardware module. Instead, the second authentication information used by the application is determined based on the third authentication information returned by the security hardware module and is associated with the first authentication information. For example, the first authentication information is the first public key of the application, while the third authentication information can be the second public key of the security hardware module. The application can generate the shared key of the application based on the second public key of the security hardware module and the first private key of the application and use the shared key of the application as the second authentication information of the application. For example, the second authentication information of the application can be calculated as aB=abG. In the embodiment, the shared key is negotiated between the application and the

security hardware module without prior sharing of the key, which ensures that even if the encrypted key to be used is intercepted during communication, an attacker cannot obtain an actual decryption key, making it difficult to crack the encrypted key to be used and enhancing a security of the encrypted key to be used.

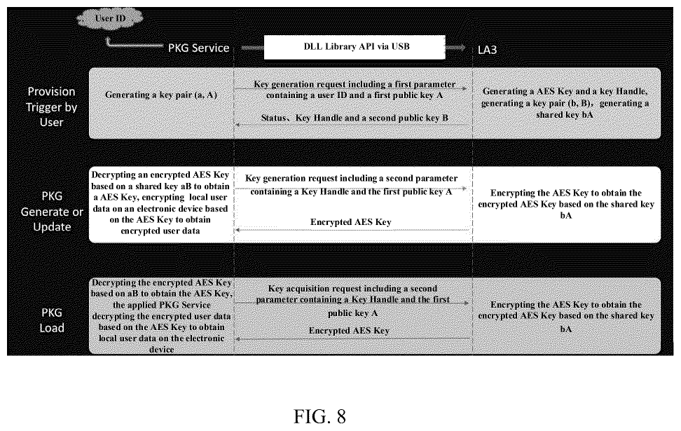

In the embodiment, a processing method is introduced from a key generation stage, a user data generation or update stage, and a loading application stage. For example, if the security hardware module can be an LA3 chip, as shown in FIG. 8, in the key generation stage (provision trigger by user), the PKG Service can generate the first key pair (i.e., key pair (a, A)) based on the ECDH encryption method. The PKG Service can send a key generation request to the LA3 chip. The key generation request contains a first parameter. The first parameter includes a user ID and a first public key (A) corresponding to the user ID (i.e., an implementation of the first authentication information). The LA3 chip can respond to the key generation request and generate a key to be used (AES Key) and an ID of the key to be used (Key Handle). A second key pair (i.e., key pair (b, B)) is generated based on the ECDH encryption method, and the shared key bA of the LA3 chip is generated based on the first public key A and the second private key b (i.e., an implementation of the second authentication information), and a corresponding relationship between the Key Handle, Status, Key ID Data and key pair (a, A) is stored in the association relationship table. The LA2 chip returns the Status, Key Handle and the second public key B (i.e., an implementation of the third authentication information) to the PKG Service.

In the user data generation or update stage (PKG Generate or Update), the PKG Service can send a key acquisition request to the LA3 chip. The key acquisition request can include a second parameter which can include the Key Handle and the first public key (A). In response to the key acquisition request, the LA3 chip encrypts the AES Key based on the shared key (bA) in the LA3 chip corresponding to the first public key (A) in the key acquisition request, obtains the encrypted AES Key, and sends the encrypted AES Key to the application. The PKG Service can derive the shared key (aB) based on the second public key (B) and the first private key (a). The PKG Service decrypts the encrypted AES Key based on the shared key (aB) to retrieve the AES Key. The AES Key is used to encrypt the local user data on the electronic device, generating encrypted user data.

After obtaining the encrypted user data, during the application loading stage (PKG Load), the PKG Service can send a key acquisition request to the LA3 chip. The key acquisition request can include a second parameter, which can include Key Handle and the first public key A. In response to the key acquisition request, the LA3 chip uses the shared key (bA) in the LA3 chip corresponding to the first public key (A) in the key acquisition request to encrypt the AES Key and sends back the encrypted AES Key to the application. The PKG Service can derive the shared key (aB) based on the second public key (B) and the first private key (a). The PKG Service can decrypt the encrypted AES Key based on the shared key (aB) to retrieve the AES Key and decrypt the encrypted user data based on the AES Key and obtain the local user data on the electronic device.

The application can send the key generation request and key acquisition request to the LA3 chip through a corresponding USB driver. The LA3 chip returns the Key Handle, Status, and encrypted AES Key through the corresponding USB driver.

As another optional embodiment of the present disclosure, a processing method is provided in Embodiment 6 of the present disclosure. The embodiment primarily implements S204 in Embodiment 2. In the embodiment, the associated data table may also include a user data ID corresponding to the user ID. S204 may include but is not limited to a following step.

S2041: obtaining the corresponding user data ID from the associated data table based on the ID of the key to be used and the user ID, retrieving the local user data on the electronic device according to the user data ID, and encrypting the data with the key to be used to obtain encrypted user data.

It can be understood that the association relationship table in S2041 may be an association relationship table managed by the application.

In the embodiment, different users may require different local user data on the electronic device for a same application. The local user data corresponding to different users can be organized into separate designated folders on the electronic device. Each folder can be labeled with a user data ID. Therefore, the user ID, the ID of the key to be used, and the user data ID can be stored in the application's association relationship table.

After receiving the ID of the key to be used from the security hardware module, a corresponding user data ID can be retrieved from the associated data table based on the ID of the key to be used and the user ID. A corresponding designated folder can be determined based on the user data ID, and the local user data can be accessed from the designated folder.

In the embodiment, by storing the user ID, the ID of the key to be used, and the user data ID in the association relationship table of the application, after receiving the ID of the key to be used from the security hardware module, the corresponding user data ID can be obtained from the association data table based on the ID of the key to be used and the user ID. The local user data on the electronic device is obtained according to the user data ID, which can improve an efficiency of obtaining local user data on the electronic device.

As another optional embodiment of the present disclosure, a processing method is provided in Embodiment 7 of the present disclosure. This embodiment primarily implements the application and association relationship table in Embodiment 2. The application may include but are not limited to a plurality of applications.

For each application, the associated data table includes the ID of the key to be used corresponding to the user ID. A same user ID has the ID of a plurality of keys to be used for a plurality of applications.

For a same user, each application can send a key generation request to the security

hardware module. In response to the key generation request, the security hardware module can determine the application from which the key generation request originates and generate the key to be used and the ID of the key to be used corresponding to the user ID and application. The IDs of the keys to be used by each application corresponding to a same user ID are different. For example, the electronic device includes applications A11, A12 and A13. User

A logs in to the application A11 through the user ID (user0001). The application A11 sends a key generation request to the security hardware module. In response to the key generation request, the security hardware module generates a key to be used (key11) and the ID of the key to be used (0x001) corresponding to the user ID (user0001) and the application A11. User A logs in to the application A12 through user ID (user0001). The application A12 sends a key generation request to the security hardware module. The security hardware module responds to the key generation request and generates a key to be used (key12) and the ID of the key to be used (0x002) corresponding to the user ID (user0001) and the application A12.

User A logs in to the application A13 through user ID (user0001). Application A13 sends a key generation request to the security hardware module. In response to the key generation request, the security hardware module generates the key to be used (key13) and the ID of the key to be used (0x003) corresponding to the user ID (user0001) and the application A13.

For example, a same user ID has IDs of a plurality of keys to be used by a plurality of applications, as shown in Table 6. (User0001) has the ID (0x001) of the key to be used by the application A11, the ID (0x002) of the key to be used by application A12, and the ID (0x003) of the key to be used by application A13.

TABLE 6

| Key Handle | Key ID Data | Key AT |
|---|---|---|
| 0x001 | user0001 | P1 |
| 0x002 | user0001 | P1 |
| 0x003 | user0001 | P1 |
| 0x01 | user0002 | P2 |
| 0x02 | user0003 | P3 |
| 0x03 | user0004 | P4 |

A same user ID can correspond to one first authentication information for a plurality of applications; or a same user ID can correspond to a plurality of, each with different first authentication information.

As another optional embodiment of the present application, a processing method is provided in Embodiment 8 of the present application. In the embodiment, there are multiple security hardware modules of the electronic device. The embodiment primarily implements S101 in Embodiment 1. S101 may include but is not limited to a following step. S1011: obtaining hardware parameters of a plurality of security hardware modules

of the electronic device, determining a target security hardware module, and hardware parameters capabilities of the target security hardware module meeting preset conditions.

In the embodiment, the preset conditions can be set according to requirements which are not limited herein. For example, hardware parameter capabilities that meet preset conditions may include but are not limited to at least one of the following conditions: a security capability meets the preset security conditions (e.g., the highest security capability); a transmission performance meets the preset transmission conditions (e.g., the highest transmission performance); a storage space meets conditions for storing a preset number of keys to be used; and the compatibility with other hardware or operating systems meets predefined fitness conditions.

In the embodiment, the key to be used may be generated only by the target security hardware module. There can also be a plurality of security hardware modules that generate keys to be used, and the plurality of security hardware modules include the target security hardware module.

S1012: obtaining the key to be used from the target security hardware module.

In the embodiment, the hardware parameter capability of the target security hardware module meets the preset conditions, which can ensure an optimization of the process of generating, storing and obtaining the key to be used. For example, selecting the target security hardware module with a highest security capability to generate and store the key to be used can ensure a security of the key storage. Selecting the target security hardware module with a highest transmission performance can guarantee a highest efficiency of transmission from the target security hardware module to the application, enhancing an efficiency of the application in obtaining the key to be used. For example, if the electronic device contains both LA1 and LA3 chips, the LA3 chip, with higher hardware parameter capabilities and higher security for encrypting user data than the LA1 chip, will be selected as the secure hardware module. The security hardware module can also be determined based on a user's active selection, such as the LA1 chip or any other chip other than LA3.

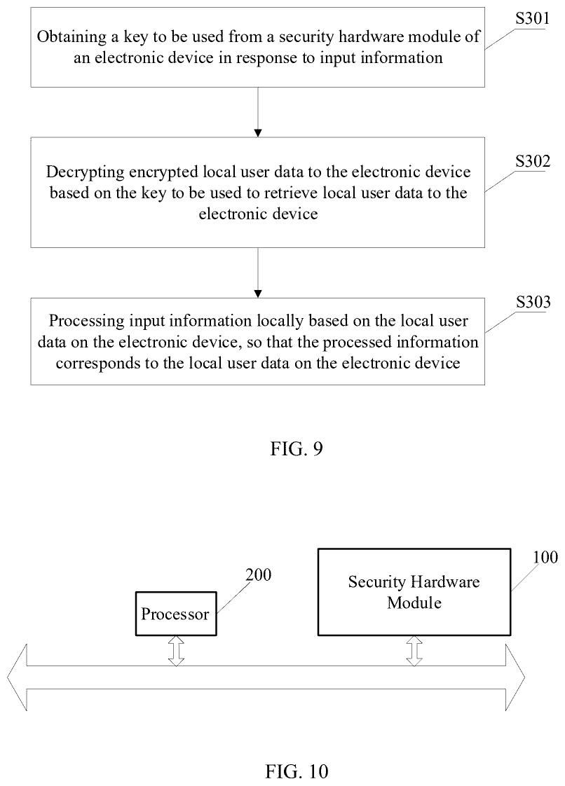

FIG. 9 illustrates a flow chart of a processing method provided in Embodiment 6 of the present disclosure. As shown in FIG. 9, the method may include but is not limited to following steps.

S301: obtaining a key to be used from a security hardware module of an electronic device in response to input information.

In the present disclosure, there is no restriction on the type of information entered. For example, the input information may include text, voice, or picture information. If the application is a generative AI application, the input information may also include prompt words or prompt phrases extracted from the input information.

If the key to be used is not obtained from the security hardware module (e.g., when a mainboard of the electronic device for installing the security hardware module is replaced, the security hardware module in the new motherboard cannot obtain the key to be used from the new motherboard because the security hardware module does not store the key to be used). The user ID of a currently logged-in application can be sent to the cloud, so that the cloud retrieve the corresponding key ID from the cloud's association relationship table, and returns the ID of the key to be used corresponding to the ID of the key to be used, so as to retrieve the key to be used, and ensure that the application can be currently used. The security hardware module will upload the association relationship table including the user ID, key ID to be used, authentication information and other corresponding relationships to the cloud, so that users can download the association relationship table from the cloud and store it on the new motherboard.

If the key to be used is not obtained from the security hardware module, in order to further improve security while ensuring that the application can currently be used, a new key to be used can be generated through the security hardware module, and the new key to be used can be used to encrypt the local user data on the electronic device, update the corresponding association relationship table, and upload the updated association relationship table and the new key to be used to the cloud.

S302: decrypting encrypted local user data to the electronic device based on the key to be used to retrieve local user data to the electronic device.

A detailed process of S302 can be referred to in a relevant introduction about decryption in the above embodiments, which will not be repeated herein.

S303: processing input information locally based on the local user data on the electronic device, so that the processed information corresponds to the local user data on the electronic device.

In the embodiment, when the application is deployed locally on the electronic

device, the local user data to the electronic device is encrypted and stored locally on the electronic device. Accordingly, the key to be used can be obtained from the security hardware module of the electronic device in response to the input information. The encrypted local user data on the electronic device is decrypted based on the key to be used to obtain the local user data to the electronic device. The input information is processed locally based on the local user data on the electronic device, so that the processed information corresponds to the local user data on the electronic device, which can enhance user experience by better addressing user needs. For example, in a context of a generative AI application, callable local models may include callable large models such as Vincentian text models, Vincentian graph models, speech models, game models, or the like. The models utilize local user data for on-device data processing.

Generative AI applications may include but are not limited to generative AI applications for office scenarios, game scenarios, educational scenarios and the like.

For example, a personal knowledge graph data service for a generative AI application in office scenarios can obtain a first key to be used from the security hardware module and encrypt first user data in a first designated folder on the electronic device based on the first key to be used, to obtain the first encrypted user data. The first user data in the first designated folder may include structured relationship data and structured vector data determined based on user data such as word documents, PPT documents, Excel documents, pictures, etc. collected and organized from a plurality of locations on the electronic device.

For example, a user can enter a prompt: “Help me search for a Word document introducing the Border Collie.” A personal knowledge graph data service for a generative AI application in office scenarios can obtain the first key to be used from the security hardware module, decrypt local first encrypted user data on the electronic device based on the first key to be used, obtain the first user data, search for a Word document introducing the Border Collie in the first user data, and output the searched Word document introducing the Border Collie.

Alternatively, for example, a user can enter a prompt “generate a photo of a dog”. A personal knowledge graph data service of a generative AI application in office scenarios can obtain a first key to be used from the security hardware module, and decrypt first encrypted user data based on the first key to be used. The generative AI application used in office scenarios can call a local Vincentian graph model to perform personalized analysis on the first user data and determine that there is a plurality of images of Border Collie dogs in the first user data.

Accordingly, the local Vincentian graph model can modify the prompt “generate a picture of a dog” to “generate a picture of a Border Collie dog” to better match the user's needs. The local Vincentian graph model can generate an image of a Border Collie dog based on the updated prompt “Generate a picture of a Border Collie dog”.

For another example, a user can enter the prompt “help me generate a Word document introducing dogs.” A personal knowledge graph data service of a generative AI application in office scenarios can obtain a first key to be used from the security hardware module and decrypt the first encrypted user data based on the first key to be used. The generative AI application used in office scenarios can call a local context graph model to perform personalized inference on the first user's data and determine that there a plurality of images of Border Collies in the first user's data. Accordingly, the local context graph model can modify the prompt “help me generate a Word document introducing dogs” to “help me generate a Word document introducing Border Collies.” The generative AI application used in office scenarios can call a local text model to generate a Word document about the Border Collie dog based on the new prompt “help me generate a Word document introducing the Border Collie dog.”

For example, a personal knowledge graph data service for a generative AI application in game scenarios can obtain a second key to be used from the security hardware module and encrypt second user data in the second designated folder local to the electronic device based on the second key to be used, to obtain the second encrypted user data. The second user data in the second designated folder may include structured relationship data and structured vector data determined derived from game data collected and organized from a plurality of games of the electronic device.

A user can enter a prompt “share my game highlight moments with friend A” in a social application. The social application can forward the prompt “share my game highlight moments with friend A” to a generative AI application used in a game scenario. The personal knowledge graph data service of the generative AI application used in the game scenario can obtain the second key to be used from the security hardware module. The second encrypted user data is decrypted based on the second key to be used to obtain the second user data. The generative AI application used in the game scene can call the local context graph model or a local game model based on the second user data to generate a video recording the game's highlight moments.

For example, the personal knowledge graph data service for a generative AI application in educational scenarios can obtain a third key to be used from the security hardware module and encrypt third user data in a third designated folder on the electronic device based on the third key to be used, to obtain the third encrypted user data. The third user data in the third designated folder may include structured relationship data and structured vector data determined derived from incorrect question data collected and organized from a plurality of locations on the electronic device.

For example, a user can enter a prompt “generate a verbal arithmetic question card” into a generative AI application for educational scenarios. A personal knowledge graph data service of the generative AI application for educational scenarios can obtain the third key to be used from the security hardware module and decrypt the third encrypted user data based on the third key to be used to obtain the third user data. The generative AI applications used in educational scenarios can call a local cultural model to perform personalized analysis on the third user data, identify commonly mistaken verbal arithmetic questions, and generate a customized arithmetic question card based on the commonly mistaken verbal arithmetic questions.

An application uses a large local model, which can not only complete work tasks offline, but also more conveniently integrate with a local knowledge base to generate more personalized works tailored to a user's style. There is no need to send data to the cloud for processing, which greatly reduces usage cost and response time, and provides users with trustworthy and secure personal data and privacy protection.

The present disclosure introduces a processing device. The following description of the processing device can be referenced in conjunction with the previously introduced processing method.

The processing device may include: a first obtaining module for retrieving a key to be used from a security hardware module of an electronic device; and an encryption module for encrypting local user data on the electronic device using the key to be used, thereby generating encrypted user data.

The processing device may further include a first sending module for transmitting a key generation request to the security hardware module of the electronic device. The key generation request includes a first parameter of the application, which includes a user ID and first authentication information corresponding to the user ID. The key generation request prompts the security hardware module to generate a key to be used and an ID of the key to be used corresponding to the first parameter and store the ID of the key to be used and a corresponding relationship between the first parameter in an association relationship table. Additionally, the processing device may include a first receiving module for receiving the ID of the key to be used from the security hardware module; and a first acquisition module for sending a key acquisition request to the security hardware module of the electronic device. The key acquisition request includes a second parameter, which includes an ID of the key to be used. The key acquisition request enables the security hardware module to retrieve the key to be used based on the second parameter and obtain the key to be used from the security hardware module.

The second parameter in the key acquisition request also includes first authentication information. The key acquisition request returns the key to be used corresponding to the ID of the key to be used in the key acquisition request when the existing first authentication information of the security hardware module matches the first authentication information in the key acquisition request.

The second parameter in the key acquisition request also includes second authentication information. The key acquisition request enables the security hardware module to use the second authentication information to encrypt the key to be used after determining the ID of the key to be used. The second authentication information is associated with the first authentication information.

The process of the first obtaining module retrieving the key to be used from the security hardware module may specifically include receiving the encrypted key to be used from the security hardware module, and decrypting the encrypted key to be used based on the second authentication information to determine the key to be used.

An associated data table may also include a user data ID corresponding to the user ID and an encryption module, which may be specifically used for retrieving a corresponding user data ID from the associated data table based on the ID of the key to be used and the user ID, retrieving local user data on the electronic device based on the user data ID and encrypting user data using the key to be used to obtain encrypted user data.

The application may include a plurality of applications. For each application, the associated data table may include an ID of a key to be used corresponding to a user ID, and a same user ID has an ID of a plurality of keys to be used for the plurality of applications. If the electronic device has a plurality of security hardware modules, the first

obtaining module can be specifically used to obtain hardware parameters of the plurality of security hardware modules of the electronic device and determine a target security hardware module whose hardware parameter capabilities meet preset conditions and obtain the key to be used from the target security hardware module.

Another processing device is provided by the present disclosure. The processing device introduced below and the processing method introduced above can be referenced correspondingly. The processing device may include: a second obtaining module, for obtaining a key to be used from a security hardware module of an electronic device in response to input information; a decryption module, for decrypting encrypted user data stored locally on the electronic device based on the key to be used, to obtain local user data in the electronic device;

and a processing module, for locally processing the input information based on the local user data on the electronic device, so that processed information corresponds to the local user data on the electronic device.

Corresponding to the above embodiment of the processing method provided by the present disclosure, the present disclosure also provides one embodiment of an electronic device. The electronic device may include a security hardware module 100, for storing a key to be used; and a processor 200 for obtaining the key to be used from the security hardware module and encrypting local user data on the electronic device based on the key to be used and obtain encrypted user data. The encrypted user data enables local processing by an application on the electronic device in response to a user input to the application.

It should be noted that each embodiment emphasizes differences from other embodiments. Same and similar parts across various embodiments can be referred to each other. Since a device embodiment is largely like the method embodiment, a description of the device embodiment is relatively simple. Relevant details can be referenced to in a partial description of the method embodiment.

It should be noted that in the present specification, relational terms such as first and second are only used to distinguish one entity or operation from another entity or operation, and do not necessarily require or imply an existence of any such actual relationship or order between the entities or operations. Furthermore, terms “comprises,” “includes,” or any other variation thereof are intended to cover a non-exclusive inclusion, such that a process, method, article, or apparatus that includes a list of elements includes not only the listed elements, but also other elements not expressly listed, or elements inherent to such process, method, article, or apparatus. Without further limitation, an element defined by the statement “comprises a . . . ” does not exclude a presence of additional identical elements in a process, method, article, or device that includes the element.

For convenience in description, functions are divided into various modules and described separately. When implementing the present disclosure, functions of each module can be implemented in a same or a plurality of software and/or hardware.

From the above description of the embodiments, a person skilled in the art can clearly understand that the present disclosure can be implemented by means of software plus a necessary general hardware platform. Based on the above, part of technical solutions of the present disclosure contributes to the prior art can be embodied in a form of software products. The software products can be stored in storage media, such as ROM/RAM, magnetic disks, optical disks, or the like, and include a set of instructions that enables a computer device (such as a personal computer, a server, or a network device, or the like) to execute the processing method described in various embodiments of the present disclosure or specific parts thereof.

As disclosed, the processing method and the electronic device provided by the present disclosure at least realize the following beneficial effects.

In the processing method, an application uses a large local model, which can not only complete work tasks offline, but also more conveniently integrate with a local knowledge base to generate more personalized works tailored to a user's style. There is no need to send data to the cloud for processing, which greatly reduces usage cost and response time, and provides users with trustworthy and secure personal data and privacy protection.

A processing method and electronic device provided by the present disclosure have been introduced in detail above. Specific embodiments in the present specification illustrate principles and implementation methods of the present disclosure. The descriptions of the above embodiments are intended to facilitate understanding of the present disclosure and core ideas thereof. For a person skilled in the art, variations in the specific implementation methods and application scope may arise based on ideas of the present disclosure. Therefore, the content of the descriptions should not be construed as a limitation of the present disclosure.

What is claimed is:

1. A processing method, performed by an electronic device, comprising:
obtaining a key to be used from a security hardware module of the electronic device; and
encrypting local user data on the electronic device based on the key to be used to generate encrypted user data, the encrypted user data being configured to enable an application on the electronic device to perform local processing in response to a user input to the application.

2. The processing method according to claim 1, further comprising:
transmitting a key generation request to a secure hardware module of the electronic device, the key generation request including a first parameter of the application containing a user ID and first authentication information corresponding to the user ID, the key generation request being configured for causing the security hardware module to generate the key to be used and an ID of the key to be used corresponding to the first parameter, and storing a corresponding relationship between the ID of the key to be used and the first parameter in an association relationship table; and
receiving the ID of the key to be used from the security hardware module.

3. The processing method according to claim 1, wherein obtaining the key to be used from the security hardware module of the electronic device includes:
transmitting a key acquisition request to the security hardware module of the electronic device, the key acquisition request including a second parameter containing an ID of the key to be used, the key acquisition request being configured to enable the security hardware module to obtain the key to be used corresponding to the second parameter based on the second parameter; and
obtaining the key to be used from the security hardware module.

4. The processing method according to claim 3, wherein the second parameter in the key acquisition request also includes first authentication information, the key acquisition request is configured to return the key to be used corresponding to the ID of the key to be used in the key acquisition request when existing first authentication information of the security hardware module is consistent with the first authentication information in the key acquisition request.

5. The processing method according to claim 3, wherein:
the second parameter in the key acquisition request further includes the first authentication information, the key acquisition request is configured to enable the security hardware module to use the second authentication information to encrypt the key to be used after determining the key to be used corresponding to the ID of the key to be used, and the second authentication information is associated with the first authentication information; and
obtaining the key to be used from the security hardware module includes receiving the encrypted key to be used from the security hardware module, and decrypting the encrypted key to be used based on the second authentication information to determine the key to be used.

6. The processing method according to claim 2, wherein an associated data table includes a user data ID corresponding to the user ID, and
encrypting the local user data on the electronic device based on the key to be used to generate the encrypted user data includes:
based on the ID of the key to be used and the user ID, obtaining a corresponding user data ID from the associated data table, and
obtaining the local user data on the electronic device according to the user data ID, and using the key to be used for encryption to obtain the encrypted user data.

7. The processing method according to claim 6, wherein:
the application includes a plurality of applications; and
for each application, the associated data table includes an ID of a key to be used corresponding to a user ID, and a same user ID has IDs of a plurality of keys to be used for a plurality of applications.

8. The processing method according to claim 1, wherein when the electronic device includes a plurality of security hardware modules, obtaining the key to be used from the security hardware module of the electronic device includes:
obtaining hardware parameters of the plurality of security hardware modules of the electronic device, and determining a target security hardware module, hardware parameter capabilities of the target security hardware module meeting preset conditions; and
obtaining the key to be used from the target security hardware module.

9. An electronic device, comprising:
a security hardware module for storing a key to be used; and
one or more processors configured to perform:
obtaining the key to be used from the security hardware module, and
encrypting local user data on the electronic device based on the key to be used to obtain encrypted user data, the encrypted user data being configured to enable an application on the electronic device to perform local processing in response to a user input to the application.

10. The electronic device according to claim 9, wherein the one or more processors are further configured to perform:
transmitting a key generation request to a secure hardware module of the electronic device, the key generation request including a first parameter of the application containing a user ID and first authentication information corresponding to the user ID, the key generation request being configured for causing the security hardware module to generate the key to be used and an ID of the key to be used corresponding to the first parameter, and storing a corresponding relationship between the ID of the key to be used and the first parameter in an association relationship table; and
receiving the ID of the key to be used from the security hardware module.

11. The electronic device according to claim 9, wherein the one or more processors are further configured to perform:
transmitting a key acquisition request to the security hardware module of the electronic device, the key acquisition request including a second parameter containing an ID of the key to be used, the key acquisition request being configured to enable the security hardware module to obtain the key to be used corresponding to the second parameter based on the second parameter; and
obtaining the key to be used from the security hardware module.

12. The electronic device according to claim 11, wherein the second parameter in the key acquisition request also includes first authentication information, the key acquisition request is configured to return the key to be used corresponding to the ID of the key to be used in the key acquisition request when existing first authentication information of the security hardware module is consistent with the first authentication information in the key acquisition request.

13. The electronic device according to claim 11, wherein:
the second parameter in the key acquisition request further includes the first authentication information, the key acquisition request is configured to enable the security hardware module to use the second authentication information to encrypt the key to be used after determining the key to be used corresponding to the ID of the key to be used, and the second authentication information is associated with the first authentication information; and
the one or more processors are further configured to perform: receiving the encrypted key to be used from the security hardware module, and decrypting the encrypted key to be used based on the second authentication information to determine the key to be used.

14. The electronic device according to claim 10, wherein an associated data table includes a user data ID corresponding to the user ID, and
the one or more processors are further configured to perform:
based on the ID of the key to be used and the user ID, obtaining a corresponding user data ID from the associated data table, and
obtaining the local user data on the electronic device according to the user data ID, and using the key to be used for encryption to obtain the encrypted user data.

15. The electronic device according to claim 14, wherein:
the application includes a plurality of applications; and
for each application, the associated data table includes an ID of a key to be used corresponding to a user ID, and a same user ID has IDs of a plurality of keys to be used for a plurality of applications.

16. The electronic device according to claim 9, wherein when the electronic device includes a plurality of security hardware modules, the one or more processors are further configured to perform:
obtaining hardware parameters of the plurality of security hardware modules of the electronic device, and determining a target security hardware module, hardware parameter capabilities of the target security hardware module meeting preset conditions; and
obtaining the key to be used from the target security hardware module.
